(19) United States
(12) Patent Application Publication
(10) Pub. No.: US 2009/0073618 A1
(43) Pub. Date: Mar. 19, 2009

(54) SURGE ABSORBING CIRCUIT CAPABLE OF REDUCING A CLAMPING VOLTAGE WITH A GREAT EXTENT

(76) Inventor: Robert WANG, Luch (TW)

Correspondence Address: SINORICA, LLC, 528 FALLSGROVE DRIVE, ROCKVILLE, MD, 20850, US

(21) Appl. No.: 11/856,736

(22) Filed: Sep. 18, 2007

(51) Int. Cl. H02H 9/04

(52) U.S. Cl. 361/56

(57) ABSTRACT

A surge absorbing circuit capable of reducing a clamping voltage with a great extent includes an input, an output, at least two inductors respectively connected between the input and the output in series, and at least two capacitances respectively connected at two sides of the inductors in parallel. The input is employed to let an AC power source pass in. The output is to transmit the AC power source having been treated by the surge absorbing circuit to a load circuit. By means of the surge absorbing circuit, the clamping voltage of the varistors can be greatly lowered and the surge can be consumed more quickly.

### BACKGROUND OF THE INVENTION

1. Field of the Invention

This invention relates to an electronic circuit, particularly a surge absorbing circuit able to greatly lower a clamping voltage.

2. Description of the Prior Art

A surge is a sudden change of voltage or current, commonly derived from flash thundering or turning on/off a current circuit. If a current circuit is attacked by a surge, it may act with an error or be seriously damaged owing to a current overload. As shown in FIG. 1, in order to keep a load circuit 1 from affected or damaged by a surge, a conventional varistor 3 is always connected between a power source 2 and the load circuit 1 in parallel. When a surge is created, it can be absorbed by the varistor 3 to be converted into thermal energy and consumed therein. Therefore, how fast the varistor 3 can consume the power created by a surge is dependent on the extent of the clamping voltage of the varistor 3. In other words, the varistor 3 having a lower clamping voltage can consume power more quickly than that having a higher clamping voltage.

### SUMMARY OF THE INVENTION

The objective of this invention is to offer a surge absorbing circuit capable of reducing a clamping voltage with a great extent.

The main characteristics of the invention are an input, an output, at least two inductors and at least two varistors. The inductors are respectively connected between the input and the output in series, and the capacitances are respectively connected at two sides of the inductors in parallel. The input is employed to let an AC power source pass in. The output is to transmit the AC power source having been treated by the surge absorbing circuit to a load circuit. By means of the surge absorbing circuit, the clamping voltage of the varistors can be greatly lowered and the surge can be consumed more quickly.

### BRIEF DESCRIPTION OF DRAWINGS

This invention is better understood by referring to the accompanying drawings, wherein:

FIG. 1 is a block diagram of a conventional surge protecting circuit;

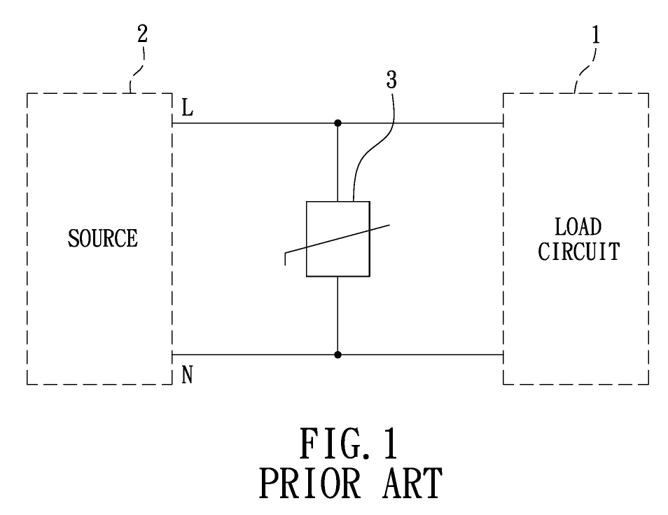

FIG. 2 is a block diagram of a first preferred embodiment of a surge absorbing circuit capable of reducing a clamping voltage with a great extent in the present invention;

FIG. 3 is a table showing the relation between a clamping voltage and inductors in the present invention;

FIG. 4 is a block diagram of a second preferred embodiment of a surge absorbing circuit capable of reducing a clamping voltage with a great extent in the present invention; and

FIG. 5 is a block diagram of a third preferred embodiment of a surge absorbing circuit capable of reducing a clamping voltage with a great extent in the present invention.

### DETAILED DESCRIPTION OF THE PREFERRED EMBODIMENT

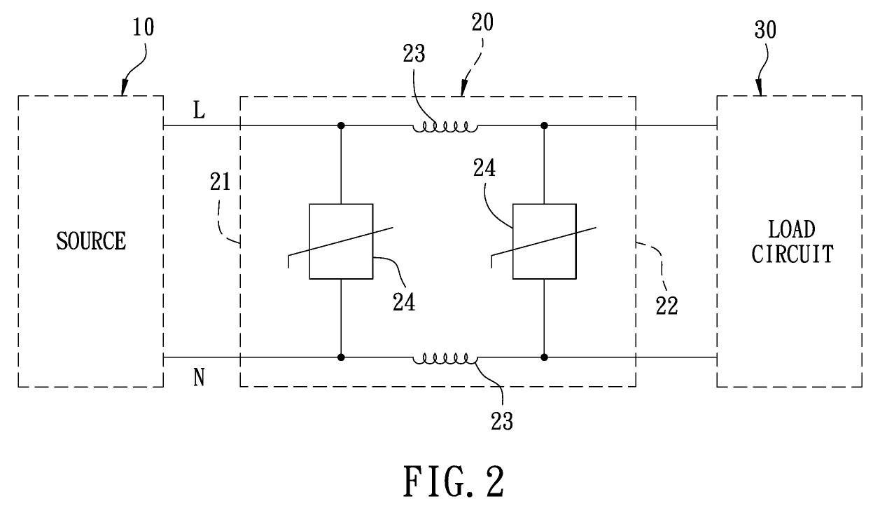

As shown in FIG. 2, a first preferred embodiment of a surge absorbing circuit 20 capable of reducing a clamping voltage with a great extent in the present invention has its one end connected with an AC power source 10 that is to be treated by the surge absorbing circuit 20 and then, outputted to a load circuit 30 connected at the other end of the surge absorbing circuit 20. The surge absorbing circuit 20 is composed of an input 21, an output 22, two inductors 23 and two varistors 24.

The input 21 is connected with each phase of an AC power source 10, which is a single-phase AC power source with an L phase and an N phase.

The output 22 is utilized to transmit the AC power source 10 having been treated to the load circuit 30.

The inductors 23 are respectively connected between the input 21 and the output 22 in series.

The varistors 24 are respectively connected between two sides of the inductors 23 in parallel.

In the surge absorbing circuit 20, each of the inductors 23 is connected with one of the varistors 24 in series. Then, the two circuits formed by the inductor 23 connected with the varistor 24 are mutually connected in parallel. One of the varistors 24 has its two ends formed as the input 21 to let the power source 10 pass in, with the L phase and the N phase of the AC power source 10 respectively connected with two ends of the varistor 24. The other varistor 24 has its two ends formed as the output 22 to let the AC power source 10 having been treated by the surge absorbing circuit 20 run out. With electric characteristics of the inductors 23 and the varistors 24, the surge absorbing circuit 20 is to create an oscillation with a time constant when the AC power source 10 passes through the surge absorbing circuit 20. So, as the AC power source 10 is accompanied by a surge to pass through the surge absorbing circuit 20, an oscillation is to be created in the surge absorbing circuit 20 to greatly lower the clamping voltage of the varistors 24, enabling the varistors 24 to more quickly absorb the surge, stabilizing more the AC power source 10 outputted from the output 22 of the surge absorbing circuit 20 to the load circuit 30.

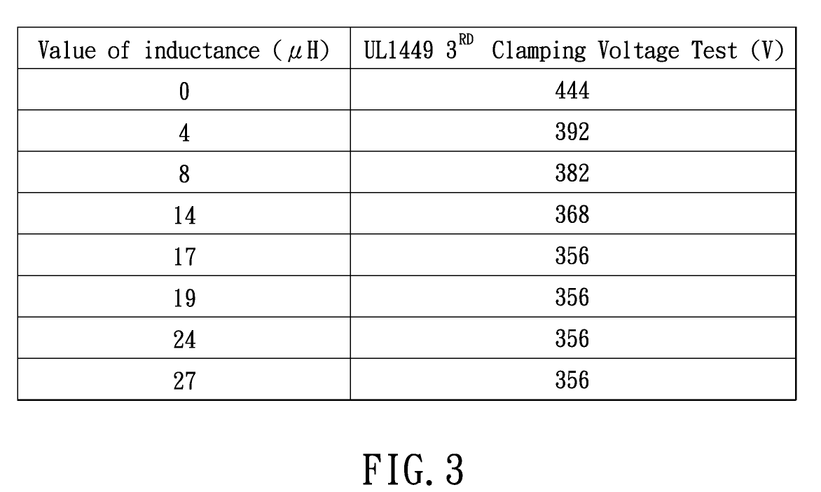

FIG. 3 is a table of a test result for the surge absorbing circuit 20, according to the standard of UL1449 3^{RD} with a test standard of 6 KV/3 KA 120Vac/90°. When the value of inductance of the inductor 23 is 0 μH, the clamping voltage of the varistor 24 is 444V, and when the value of inductance of the inductor 23 is increased up to more than 17 μH, the clamping voltage of the varistor 24 is to reach a steady value of 356V. Obviously, via the surge absorbing circuit 20, 88V is lowered for the clamping voltage of the varistor 24. As the extent of the breakdown voltage of the varistor 24 is related with if the varistor 24 is operated or not, the clamping voltage of the varistor 24 can be lowered below 330V by changing the breakdown voltage of the varistor 24 while manufacturing.

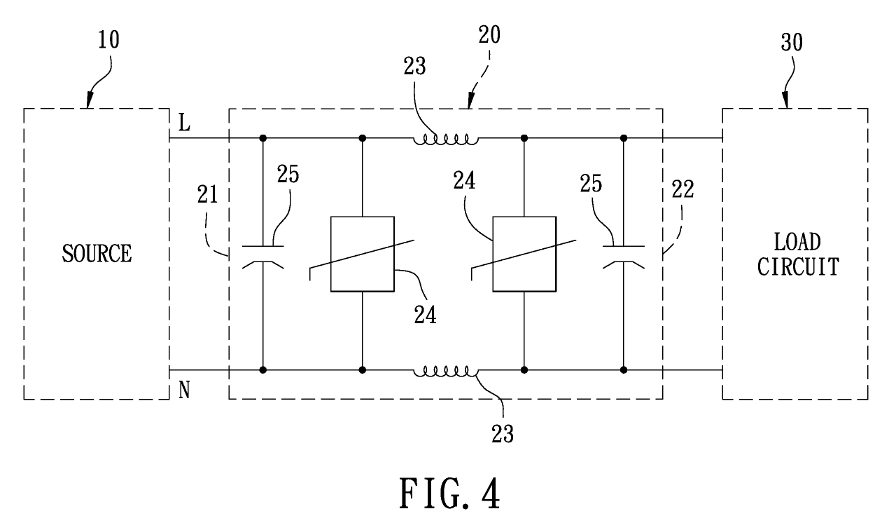

As shown in FIG. 4, a second preferred embodiment of a surge absorbing circuit capable of reducing a clamping voltage with a great extent in the present invention has the same components as the first embodiment does, except additionally using a capacitor 25 to respectively connect with the varistors 24 in parallel. By means of the capacitors 25 possessing characteristics of charging and discharging, ripples coming out from the output 22 of the surge absorbing circuit 20 can be reduced to strengthen the stability of the power source coming out from the output 22.

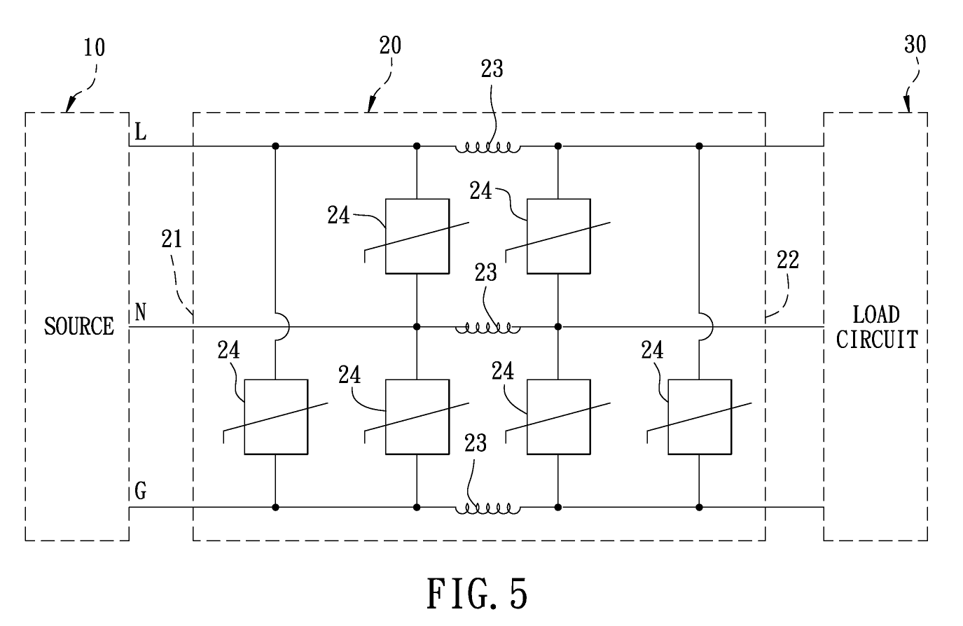

As shown in FIG. 5, a third preferred embodiment of a surge absorbing circuit capable of reducing a clamping voltage with a great extent in the present invention has the same components as the first embodiment does, except that the AC power source 10 is a three-phase one instead of a single phase one in the first embodiment. The three-phase AC power source 10 has an L phase, an N phase and a G phase. The input 21 of the surge absorbing circuit 20 is respectively connected between L-N, L-G and N-G, keeping the surge absorbing circuit 20 connected between every two phases, so that if a surge is created in any phase of the AC power source 10, it can be previously absorbed by the surge absorbing circuit 20 before transmitted through the output 22 to the load circuit 30.

While the preferred embodiment of the invention has been described above, it will be recognized and understood that various modifications may be made therein and the appended claims are intended to cover all such modifications that may fall within the spirit and scope of the invention.

What is claimed is:

1. A surge absorbing circuit capable of reducing a clamping voltage with a great extent, said surge absorbing circuit disposed between every phase of an AC power source input and comprising:
an input for an AC power source to pass in;
an output for connecting with a load circuit;
two inductors respectively connected between said input and said output of each phase in series; and
two varistors respectively connected at two sides of said inductors in parallel.

2. The surge absorbing circuit capable of reducing a clamping voltage with a great extent as claimed in claim 1, wherein said AC power source is a single phase one.

3. The surge absorbing circuit capable of reducing a clamping voltage with a great extent as claimed in claim 1, wherein said AC power source is a three-phase one.

4. The surge absorbing circuit capable of reducing a clamping voltage with a great extent as claimed in claim 1, wherein said varistors are respectively connected with a capacitor in parallel.

5. The surge absorbing circuit capable of reducing a clamping voltage with a great extent as claimed in claim 1, wherein a clamping voltage of said varistors is lowered below 330V via changing a breakdown voltage of said varistors while manufacturing, under an UL 1449 3^{RD} test for said surge absorbing circuit with a standard volume 6 KV/3 KA.
